(19) United States
(12) Patent Application Publication
(10) Pub. No.: US 2011/0119622 A1
(43) Pub. Date: May 19, 2011

(54) WINDOW DISPLAY CONTROL APPARATUS AND METHOD OF CONTROLLING WINDOW DISPLAYS

(75) Inventors: Yohei Niki, Atsugi-shi (JP); Eiji Takeda, Atsugi-shi (JP); Tadanori Nishikobara, Atsugi-shi (JP); Keita Masuhara, Atsugi-shi (JP); Takashi Murakami, Atsugi-shi (JP)

(73) Assignee: ANRITSU CORPORATION, Atsugi-shi (JP)

(21) Appl. No.: 12/944,137

(22) Filed: Nov. 11, 2010

(30) Foreign Application Priority Data
Nov. 17, 2009 (JP) 2009-262025

(51) Int. Cl. G06F 3/048

(52) U.S. Cl. 715/788

(57) ABSTRACT

A plurality of display windows corresponding to a plurality of applications is formed from a plurality of fixed window frames that is displayed with regularity on one display screen of a display unit. A display control unit performs display control by sequentially displaying displays relating to the plurality of applications in a switching manner in the order in which the plurality of applications is selected in a time series in the fixed window display frames that are displayed with regularity on one display screen of the display unit when the plurality of applications is selected in the time series.

### BACKGROUND

1. Technical Field

The present invention relates to a window display control apparatus and a method of controlling window displays that are appropriate for allowing a user to perform a desired operation while simultaneously viewing a plurality of display windows by displaying the plurality of display windows corresponding to a plurality of applications on one display screen.

2. Related Art

In recent personal computers, user interfaces have markedly improved, and cases where a desired operation (data display or data processing) is performed while a plurality of display windows is simultaneously viewed by displaying the plurality of display windows corresponding to a plurality of applications on one display screen have increased in frequency. In such a situation, in a user interface, there is a need for improvement in regard to the operation environment and visual convenience of use. Accordingly, as a solution thereof, many methods of controlling window displays are considered.

For example, as a method of controlling a plurality of windows in a window system type, as disclosed in Japanese Unexamined Patent Publication No. 6-67834, means for performing display control for a plurality of display windows to which priority levels are assigned in accordance with the use states thereof by using respective priority information by measuring elapsed time after access and assigning priority levels thereto based on the measured lengths of the elapsed time periods have been considered.

However, it cannot be easily determined whether performing display control by counting the number of instances of access and assigning priority levels, like the general method of controlling a plurality of windows that is disclosed in the above-described Japanese Unexamined Patent Publication No. 6-67834, relates to a display window that is needed for the user. In addition, according to Japanese Unexamined Patent Publication No. 6-67834, there is an inconvenience that, in order to perform an intuitive operation, the user must acquire the position of the display window each time when the operation is performed.

In addition, in a case where a plurality of display windows is displayed, the complexity is lost due to display without any order or regularity, the position of the display window needs to be acquired constantly due to the free layout of the inside of the display window frame in a window system, and there is a possibility that the window environment becomes more complicated due to variability in size.

In addition, in a case where an operation is performed while a plurality of applications is simultaneously viewed by displaying the plurality of applications on one display screen, there are various ways to achieve user convenience. Thus, from among these ways, how the plurality of display windows is controlled so as to achieve user convenience becomes key.

### SUMMARY

The present invention is contrived in consideration of the above-described problems. The object of the present invention is to provide a window display control apparatus and a method of controlling window displays, in which a user does not need to constantly acquire the position of the display window and which can be conveniently used by the user.

In order to achieve the above-described object, according to a first embodiment of the present invention, there is provided a method of controlling window displays in which a plurality of display windows corresponding to a plurality of applications used for measuring electric signals and a plurality of fixed window display frames used for displaying the plurality of display windows on one display screen are controlled so as to be displayed. The method includes: selecting one of the plurality of applications as a first application; displaying a first display window corresponding to the selected first application in a first fixed window display frame; selecting one of the plurality of applications other than the first application as a second application; displaying the first display window displayed in the first fixed window display frame in the second fixed window display frame when the second application is selected; and displaying the second display window corresponding to the second application in the first fixed window display frame.

According to a second embodiment of the present invention, in the above-described method, displaying a top menu including function menu buttons having a one-to-one corresponding relationship with said plurality of applications to be selected; and displaying the function menu button corresponding to said selected application in an identifiable manner is further included.

According to a third embodiment of the present invention, there is provided a window display control apparatus including: a display unit that includes a plurality of display windows corresponding to a plurality of applications used for measuring electric signals and a plurality of fixed window display frames used for displaying the plurality of display windows on one display screen; an application selection unit that is used for selecting any one of the plurality of applications; and a display control unit, when the application is selected by the application selecting unit in a state in which the display window is displayed in advance in the first fixed window display frame out of the plurality of fixed window display frames that is located at a predetermined position, controls to display the display window displayed in advance in the first fixed window display frame in the second fixed window display frame located at a predetermined position and to newly display the display window corresponding to the application selected by the application selecting unit in the first fixed window display frame.

In the above-described window display control apparatus, the display control unit displays function menu buttons (8a to 8e) having a one-to-one corresponding relationship with said plurality of applications to be selected as well as displaying the function menu button corresponding to said selected application in an identifiable manner.

According to an embodiment of the present invention, a user does not need to constantly acquire the position of the display window unlike in a general case, and the user can display a display relating to a desired application at that time in a fixed window display frame. Therefore, user convenience can be improved.

In addition, since an application corresponding to the fixed window display frame displayed on a display unit is displayed in an identifiable manner, the user can explicitly visually recognize that the fixed window display frame is a display relating to a specific application.

### BRIEF DESCRIPTION OF THE DRAWINGS

FIG. 1 is a configuration block diagram of a window display control apparatus according to an embodiment of the present invention.

FIG. 2 is a diagram showing a display example of a fixed window display frame in a window display control apparatus according to an embodiment of the present invention.

FIG. 3 is a diagram showing a specific display example of a fixed window display frame in a window display control apparatus according to an embodiment of the present invention.

FIGS. 4A, 4B, and 4C are diagrams showing other forms of a fixed window display frame in a window display control apparatus according to an embodiment of the present invention.

### DESCRIPTION OF EXEMPLARY EMBODIMENTS

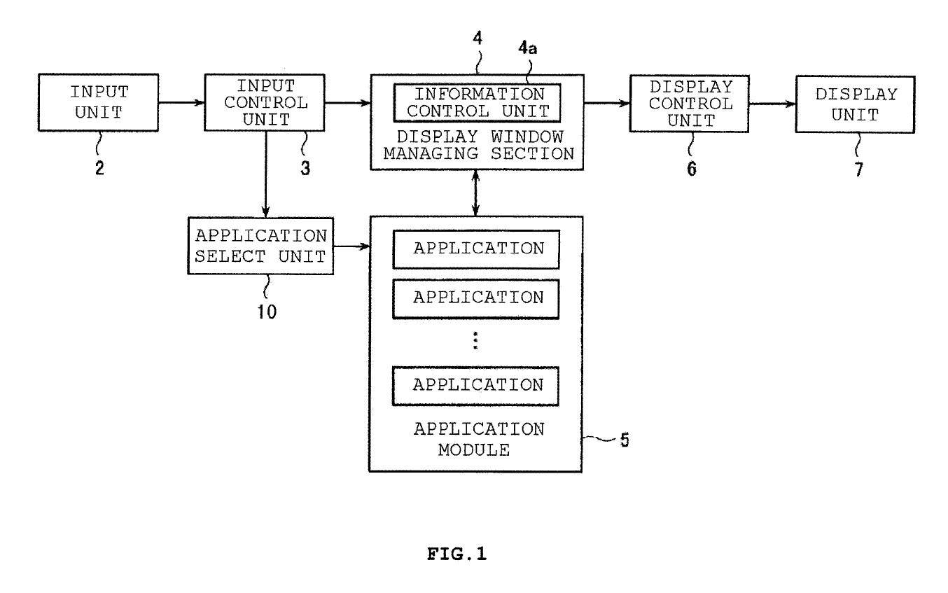

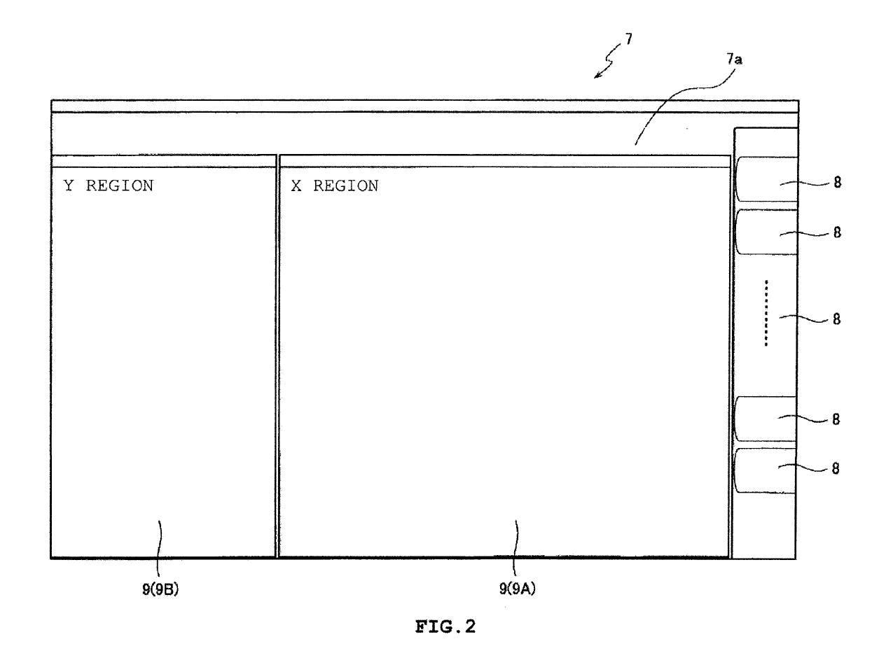

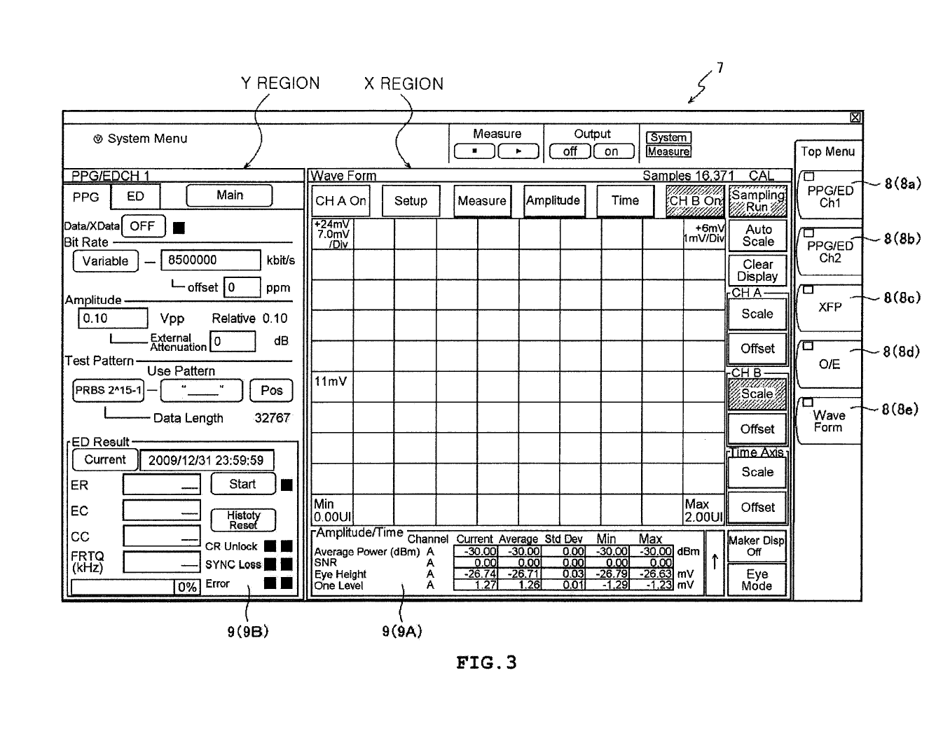

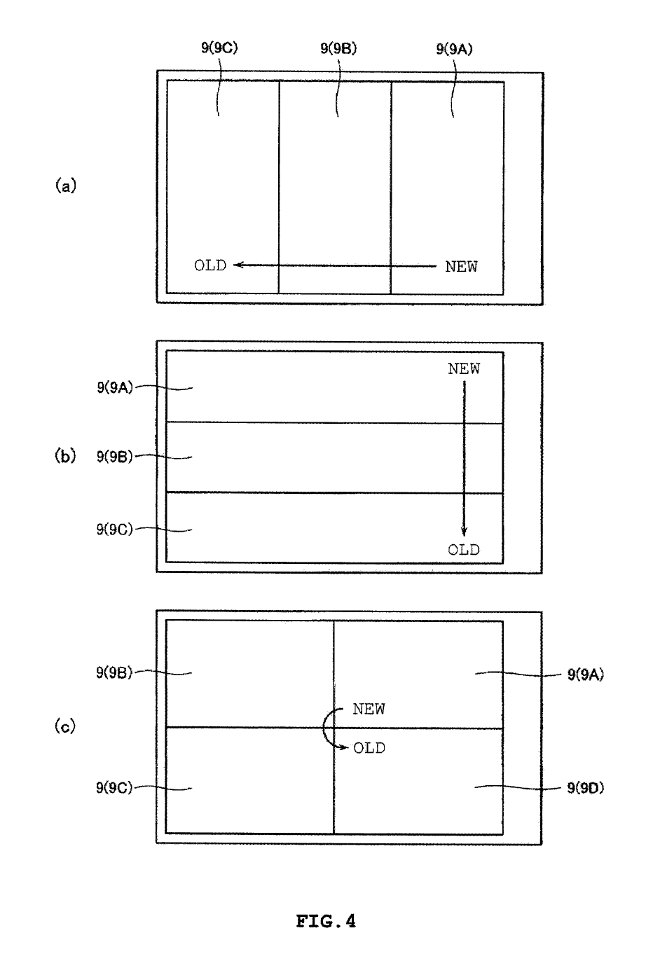

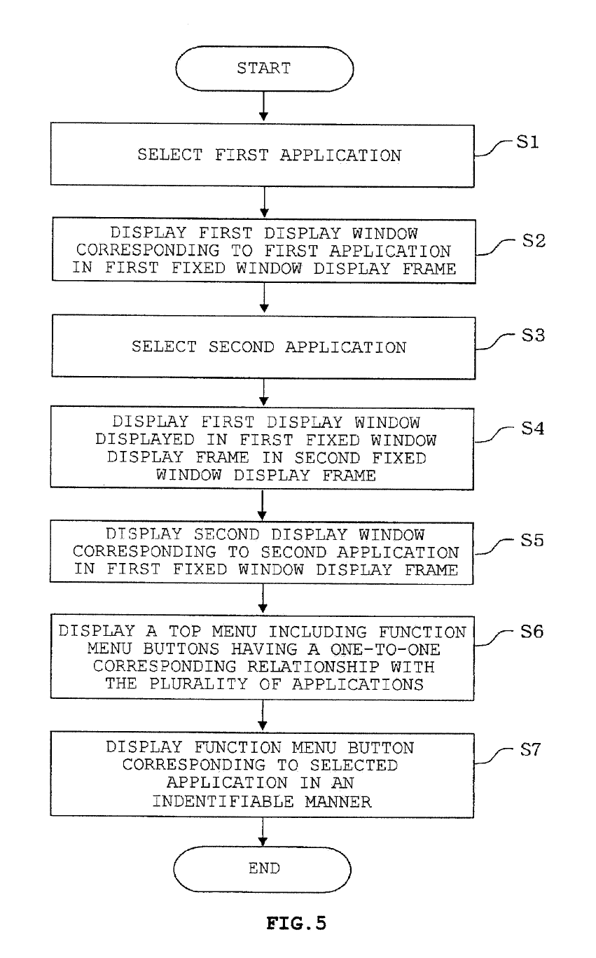

Hereinafter, embodiments of the present invention will be described in detail with reference to the accompanying drawings. FIG. 1 is a configuration block diagram of a window display control apparatus according to an embodiment of the present invention. FIG. 2 is a diagram showing a display example of the fixed window display frame in the window display control apparatus. FIG. 3 is a diagram showing a specific display example of the fixed window display frame in the window display control apparatus. FIGS. 4A to 4C are diagrams showing other forms of the fixed window display frame in the window display control apparatus.

A window display control apparatus according to an embodiment of the present invention is built into a measurement device that performs various measurements (for example, measurement of an error rate, measurement of a signal, or the like) when performing a user's desired application. The window display control apparatus is appropriate for allowing a user to perform a desired operation (the displaying or processing of data) while simultaneously viewing a plurality of display windows by displaying the plurality of display windows corresponding to a plurality of applications on one display screen when the user starts the plurality of desired applications.

As shown in FIG. 1, the window display control apparatus 1 of this example is built by an input unit 2, an input control unit 3, a display window managing unit 4, an application module 5, a display control unit 6, a display unit 7, and an application control unit 10.

The input unit 2 inputs information that is needed when various operations are performed by starting an application and is configured by an input device that is operated by a user. More specifically, this input unit 2 is configured by an input device such as a pointing device, for example, a mouse or the like, a touch panel configured by soft keys on a display screen 7a of the display unit 7, or the like.

The input unit 2, as shown in FIGS. 2 and 3, operates when function menu buttons 8 that are configured by a plurality of soft keys disposed on the display screen 7a of the display unit 7 are selectively pressed down. A plurality of the function menu buttons 8 that is selectively pressed down in accordance with the operation of the input unit 2 displays a top menu relating to each application of an application module 5 and has a one-to-one correspondence relationship with applications of the application module 5.

A signal transmitted from the function menu button 8 that has been selectively pressed transmits the selection of one of the plurality of applications to the application selecting unit 10 through the input control unit 3. The application selecting unit 10 transmits the selection of one of the applications selected by the function menu button 8 to the application module 5.

The input control unit 3 determines which one of the plurality of the function menu buttons 8 has been selected and pressed (which one of the plurality of applications is selected) based on information (coordinate axis information) at the time of the operation of the input unit 2 and outputs the information on the function menu button determined as being pressed to the display window managing unit 4 as a result of the determination.

The display window managing unit 4 performs overall management of a drawing operation of the display unit 7 by using the display control unit 6 based on the result of the determination output from the input control unit 3. In addition, the display window managing unit 4 calls up an application corresponding to the result of the determination, which is output from the input control unit 3, from the application module 5 so as to be started.

The display window managing unit 4 includes an information determining section 4a so as to control the drawing of a fixed window display frame 9, which is performed by the display unit 7, by using the display control unit 6. When receiving the result of determination (information on a function menu button 8 that has been pressed) from the input control unit 3 as input, the information determining section 4a outputs display information on the application corresponding to the fixed window display frame 9 to the display control unit 6 by referring to current configuration information (the sequence of pressing of the function menu buttons 8 and the display state of the current fixed window display frame 9).

The current configuration information is updated and stored each time when the fixed window display frame 9 is displayed on the display unit 7.

The application module 5 is configured by a plurality of applications that is formed by software or programs used for performing various measurements. The plurality of applications, for example, is formed by software or a program that measures an error rate by generating a desired pulse-pattern signal, transmitting the pulse-pattern signal to an object to be measured, and receiving a signal returning back from the object to be measured that is accompanied with the transmission, software or a program that measures a transmission signal for an object to be measured or a signal received from an object to be measured and displays the waveform thereof, or the like.

In addition, each application that configures the application module 5 can operate independently. Thus, each application can operate even in the state in which display relating to the application is not performed in the fixed window display frame 9.

The display control unit 6 controls the drawing operation (drawing of the entire display screen including the function menu buttons 8 and drawing of the fixed window display frame 9) of the display unit 7 under the management of the display window managing unit 4.

When applications are selected in a time series in accordance with the operation of the input unit 2, the display control unit 6 performs display control by sequentially displaying displays relating to each application in the order in which the applications are selected in the time series, in a switching manner in the fixed window display frame 9 that is displayed in a predetermined area of one display screen 7a of the display unit 7 with regularity.

Described in more detail, the display control unit 6 of this example performs display control such that a display relating to an application corresponding to the function menu button 8 that has been most recently pressed at the current time point and a display relating to an application corresponding to a function menu button 8 that was pressed immediately prior to this time are displayed in two fixed window display frames 9 on the display screen 7a of the display unit 7 with regularity. More specifically, in FIG. 2, in a case where a fixed window display frame 9A of an X region out of two fixed window display frames 9 is displayed in advance, when the function menu button 8 is pressed in accordance with an operation of the input unit 2, the fixed window display frame 9A of the X region displayed in advance is moved so as to be displayed in a fixed window display frame 9B of a Y region, and a display relating to the application for which the function menu button 8 has been pressed is newly displayed in the fixed window display frame 9A of the X region.

Furthermore, the operation of the software will be described with reference to FIG. 5.

When the function menu button 8 is pressed down by the operation of the input unit 2 (S1), the first display window corresponding to the selected first application is displayed in the first fixed window display frame (S2), and one application other than the first application is selected as the second application (S3). Then, when the second application is selected, the first display window displayed in the first fixed window display frame is displayed in the second fixed window display frame (S4), and the second display window corresponding to the second application is displayed in the first fixed window display frame (S5).

When the next application is further selected, the operations of S3 to S5 are repeated.

The display control unit 6 displays applications corresponding to the fixed window display frames 9 that are displayed on the display screen 7a of the display unit 7 in an identifiable manner. Described in more detail, in order to allow a user to recognize that the fixed window display frame 9 displayed on the display unit 7 is a display relating to a specific application, the display control unit 6 displays the function menu button 8 corresponding to the application in an identifiable manner such as lighting, blinking, or color classification in accordance with the display information received from the information determining section 4a. For example, as shown in FIG. 2, in a case where two fixed window display frames 9A and 9B are displayed, the function menu button 8 that has been most recently pressed at the current time point is lit, and the function menu button 8 that was previously pressed is blinking.

Furthermore, the operation of the software will be described with reference to FIG. 5.

In Step S6 in which displays a top menu including function menu buttons having a one-to-one corresponding relationship with said plurality of applications to be selected, and in Step (S7) in which displays the function menu button corresponding to said selected application in an identifiable manner, since the user is recognized that each fixed window display frame 9 is a display relating to a specific application in Step S1 of selecting the first application and Step S3 of selecting the second application, the function menu buttons 8 corresponding to the applications are displayed in identifiable manners such as lighting, blinking or color classification.

The display unit 7 is configured, for example, by a liquid crystal display and displays the function menu buttons 8 corresponding to each application on the display screen 7a (FIG. 2 and the right side in FIG. 3) and displays the fixed window display frames 9 corresponding to the operation of the input unit 2 so as to be displayed on one display screen 7a, under the control of the display control unit 6.

Next, a display method performed by the window display control apparatus 1 having the above-described configuration will be described. Here, as shown in FIG. 2, the maximum number of the fixed window display frames 9 displayed on the display unit 7 is assumed to be two, and a case where the fixed window display frame 9A of the X region is displayed on the display unit 7 in advance will be described as an example.

When a user operates the input unit 2 so as to perform a desired application, the input control unit 3 determines which one of a plurality of function menu buttons 8 is pressed (which one of a plurality of applications is selected) based on the information (the coordinate axis information) at the time of operation of the input unit 2 and outputs the information on the function menu button 8 determined to have been pressed to the display window managing unit 4 as a result of the determination.

The display window managing unit 4 reads out and starts the application corresponding to the result of the determination, which is received from the input control unit 3, from the application module 5. Simultaneously, when the result of the determination (the information on the pressed function menu button 8) is input from the input control unit 3, the information determining section 4a of the display window managing unit 4 outputs display information on the application to be displayed in the fixed window display frame 9 to the display control unit 6 by referring to the current configuration information (the pressing sequence of the function menu button 8 and the display state of the current fixed window display frame 9).

Then, the display control unit 6 moves the display relating to the old application before the most recent pressing of the function menu button 8 with respect to the current time point from the fixed window display frame 9A of the X region to the fixed window display frame 9B of the Y region so as to be displayed therein and displays the display relating to the application corresponding to the function menu button 8 that has been most recently pressed at the current time point in the fixed window display frame 9A of the X region, based on the display information received from the information determining section 4a. Simultaneously, the display control unit 6 displays the function menu buttons 8 corresponding to each application of the fixed window display frames 9A and 9B displayed on the display unit 7 in an identifiable manner such as lighting, blinking, or color classification.

The above-described operation is repeated each time when a user operates the input unit 2. In the fixed window display frame 9A of the X region, a display relating to the application corresponding to the function menu button 8 that has been most recently pressed at the current time point is displayed. In addition, in the fixed window display frame 9B of the Y region, a display relating to the application corresponding to the function menu button 8 pressed at the time immediately before that is moved from the fixed window display frame 9A of the X region so as to be displayed.

Furthermore, FIG. 3 shows a specific display example of the fixed window display frame 9 in the window display control apparatus 1. As shown in FIG. 2, five function menu buttons 8 (8a, 8b, 8c, 8d, and 8e) including “PPG/ED ch1”, “PPG/ED ch2”, “XFP”, “O/E”, and “Wave Form” are disposed on the display screen 7a of the display unit 7.

In this state, when a user presses the function menu button 8e of “Wave Form” after pressing the function menu button 8a of “PPG/ED ch1”, on one display screen 7a of the display unit 7, a display relating to the application of “Wave Form” that has been most recently pressed is displayed in a fixed window display frame 9A positioned on the right side, and a display relating to the application of “PPG/ED ch1” pressed at the time immediately before that is displayed in the fixed window display frame 9B positioned on the left side. Then, the function menu button 8a of “PPG/ED ch1” corresponding to the fixed window display frame 9A and the function menu button 8e of “Wave Form” corresponding to the fixed window display frame 9B are, for example, respectively lit in green.

As above, according to an embodiment of the present invention, the function menu buttons 8 used for displaying displays relating to each application in a plurality of fixed window display frames 9 that is fixed in advance are disposed on the display screen 7a of the display unit 7. Thus, when a function menu button 8 corresponding to a desired application is pressed in accordance with the operation of the input unit 2, the current configuration information (the sequence of pressing of the function menu buttons and the state of the current fixed window display frame) is referred to. When the number of the fixed window display frames 9 is two as shown in FIG. 2, based on the information on the pressed function menu buttons 8 and the current configuration information, a display relating to an application corresponding to the function menu button 8 that has been most recently pressed at the current time point is displayed in a fixed window display frame 9A positioned in an X region, and a display relating to an application corresponding to the function menu button 8 pressed at the time immediately before that is displayed in a fixed window display frame 9B positioned in a Y region.

In other words, according to an embodiment of the present invention, displays relating to applications are regularly displayed in the fixed window display frames 9 in the order in which the function menu buttons 8 are pressed in a time series by operating the input unit 2, thereby realizing an intuitive and easy operation method for a user.

Accordingly, in a plurality of the fixed window display frames 9 that is fixed in advance, displays relating to applications corresponding to the function menu buttons 8 pressed retroactively from the most recent time with respect to the current time point can be regularly displayed. Therefore, a user can acquire the position of the display window with less effort. In addition, by eliminating the degree of freedom of display windows, the user can operate the layout so as to have regularity and the order within the fixed frame according to the fixed window display frames 9.

In addition, a display relating to a needed application can be displayed in the fixed window display frame 9 at a necessary time by a user's operation for the input unit 2. At that time, in order to allow the display relating to the application that is displayed in the fixed window display frame 9 to be explicitly understood, the function menu button 8 of the application corresponding to the fixed window display frame 9 displayed on the display unit 7 is displayed in an identifiable manner. Accordingly, the user's visual recognition can be improved.

In the above-described embodiment, a case where a maximum of two fixed window display frames 9 fixed in advance are displayed in one display screen 7a has been described as an example. However, as long as the fixed window display frames 9 are displayed on one display screen 7a with regularity, the number of the fixed window display frames 9 is not limited to two. For example, the fixed window display frames 9 as shown in FIGS. 4A to 4C can be displayed on one display screen 7a of the display unit 7.

FIG. 4A is an example in which three fixed window display frames 9A, 9B, and 9C are horizontally displayed on the display screen 7a of the display unit 7. In this display example, a display relating to an application corresponding to a function menu button 8 that has been most recently pressed is displayed in the fixed window display frame 9A positioned on the right side, a display relating to an application corresponding to a function menu button 8 pressed at the time immediately before that is displayed in the fixed window display frame 9B positioned in the center, and a display relating to an application corresponding to a function menu button 8 pressed at the time before that is displayed in the fixed window display frame 9C positioned on the left side.

FIG. 4B is an example in which three fixed window display frames 9A, 9B, and 9C are vertically displayed on the display screen 7a of the display unit 7. In this display example, a display relating to an application corresponding to a function menu button 8 that has been most recently pressed is displayed in the fixed window display frame 9A positioned on the upper side, a display relating to an application corresponding to a function menu button 8 pressed at the time immediately before that is displayed in the fixed window display frame 9B positioned in the center, and a display relating to an application corresponding to a function menu button 8 pressed at the time before that is displayed in the fixed window display frame 9C positioned on the lower side.

FIG. 4C is an example in which four fixed window display frames 9A, 9B, and 9C and 4D are displayed on the display unit 7. In this display example, a display relating to an application corresponding to a function menu button 8 that has been most recently pressed is displayed in the fixed window display frame 9A positioned on the upper right side, a display relating to an application corresponding to a function menu button 8 pressed at the time immediately before that is displayed in the fixed window display frame 9B positioned on the upper left side, a display relating to an application corresponding to a function menu button 8 pressed at the time before that is displayed in the fixed window display frame 9C positioned on the lower left side, and a display relating to an application corresponding to a function menu button 8 pressed at the time before that is displayed in the fixed window display frame 9D positioned on the lower right side.

In order to allow a user to recognize that the fixed window display frame 9 displayed on the display unit 7 is a display relating to a specific application, the function menu button 8 corresponding to the application of the fixed window display frame 9 is configured to be displayed in an identifiable manner such as lighting, blinking, or color classification. However, the application of the fixed window display frame 9 can be displayed in an identifiable manner by using a different configuration. For example, a title bar portion of the fixed window display frame 9 displayed on the display unit 7 can be displayed in an identifiable manner through color classification.

Furthermore, when the function menu buttons 8 cannot be displayed in the display region of the display unit 7 in accordance with an increase in the applications of the application module 5, the function menu buttons 8 may be divided into a plurality of pages. In such a case, a soft key that is used for switching between pages is provided on the display screen 7a of the display unit 7, and arbitrarily switching between the pages of the function menu buttons 8 can be performed so as to allow display by using the soft key used for switching between the pages.

What is claimed is:

1. A method of controlling a window display in which a plurality of display windows corresponding to a plurality of applications used for measuring electric signals and a plurality of fixed window display frames(9) used for displaying the plurality of display windows on one display screen(7a) are controlled so as to be displayed,
the method comprising:
step(S1) for selecting one of said plurality of applications as a first application;
step(S2) for displaying a first display window corresponding to said selected first application in the first fixed window display frame;
step(S3) for selecting one of the plurality of applications other than the first application as a second application;
step(S4) for displaying said first display window in the second fixed window display frame when said second application is selected; and
step(S5) for displaying the second display window corresponding to said second application in said first fixed window display frame.

2. The method according to claim 1, further comprising:
step(S6) for displaying a top menu including function menu buttons having a one-to-one corresponding relationship with said plurality of applications to be selected; and
step (S7) for displaying the function menu button corresponding to said selected application in an identifiable manner.

3. A window display control apparatus comprising:
a display unit(7) that includes a plurality of display windows corresponding to a plurality of applications used for measuring electric signals and a plurality of fixed window display frames(9) used for displaying said plurality of display windows on one display screen(7a);
an application selection unit(10) that is used for selecting any one of said plurality of applications; and
a display control unit(6), when the application is selected by said application selecting unit in a state in which the display window is displayed in advance in the first fixed window display frame out of the plurality of fixed window display frames that is located at a predetermined position, controls to display said display window in the second fixed window display frame located at a predetermined position and to newly display the display window corresponding to said application selected by said application selecting unit in the first fixed window display frame.

4. The window display control apparatus according to claim 3, wherein said display control unit displays function menu buttons (8a to 8e) having a one-to-one corresponding relationship with said plurality of applications to be selected as well as displaying the function menu button corresponding to said selected application in an identifiable manner.
